(19) United States
(12) Patent Application Publication
(10) Pub. No.: US 2026/0148275 A1
(43) Pub. Date: May 28, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Masayuki Fukui, Kanagawa (JP)

(21) Appl. No.: 19/451,917

(22) Filed: Jan. 16, 2026

Related U.S. Application Data
(63) Continuation of application No. 17/866,295, filed on Jul. 15, 2022, now abandoned.

(30) Foreign Application Priority Data
Jul. 19, 2021 (JP) 2021-118475

(51) Int. Cl. G06Q 30/0601

(52) U.S. Cl. CPC G06Q 30/0625

(57) ABSTRACT

An information processing apparatus includes an acquiring unit configured to acquire product identification information from a reference source web page, and a setting unit configured to set, in a case where the product identification information is acquired, a URL based on the acquired product identification information in a hyperlink in a product common page which is commonly used among a plurality of products, and wherein, in a case where the hyperlink is selected, a web page related to a product corresponding to the product identification information is displayed.

### CROSS REFERENCE OF RELATED APPLICATIONS

This application is a continuation of U.S. Patent Application No. 17/866,295, filed on July 15, 2022, which claims the benefit of Japanese Patent Application No. 2021-118475, filed July 19, 2021, which is hereby incorporated by reference herein in its entirety.

### BACKGROUND

### Field of the Disclosure

The present disclosure relates to an information processing apparatus, a control method, and a storage medium.

### Description of the Related Art

Japanese Patent No. 4669000 discusses a technique for improving user convenience in web (i.e., a worldwide web) pages. According to the technique discussed in Japanese Patent No. 4669000, in a case where a web page is shifted from a product common page to a product-specific page, a web page is displayed using a content corresponding to a cookie name.

However, some users do not accept cookies on web browsers by users' operations, and disable functions using cookies. Consequently, since cookies are set to be available for not all the web browser users, there can be a case where a conventional technique reduces a user's opportunity for receiving a benefit of a highly convenient web page display technique.

### SUMMARY

According to an aspect of the present disclosure, a method for an information processing apparatus that displays a product common page which is commonly used among a plurality of products, the method includes acquiring product identification information from a reference source web page, and setting, in a case where the product identification information is acquired, at least some of Uniform Resource Locator (URL) information based on the acquired product identification information in a hyperlink in a product common page which is commonly used among a plurality of products, wherein, in a case where the hyperlink is selected, a web page related to a product corresponding to the product identification information is displayed.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of a web page display system.

FIG. 2 is a diagram illustrating an example of a web page flow.

FIG. 3 is a diagram illustrating an example of a web page flow.

FIG. 4 is a diagram illustrating an example of a web page flow.

FIG. 5 is a flowchart illustrating a processing procedure according to one or more aspects of the present disclosure.

FIGS. 6A and 6B are diagrams each illustrating an example of a web page flow.

FIG. 7 is a flowchart illustrating a processing procedure according to one or more aspects of the present disclosure.

FIG. 8 is a diagram illustrating an example of a hardware configuration of an information processing apparatus.

### DESCRIPTION OF THE EMBODIMENTS

Various exemplary embodiments of the present disclosure will be described in detail below with reference to the attached drawings. The exemplary embodiments which will be described below do not restrict the present disclosure according to the claims. All of combinations of the features described in the exemplary embodiments are not always essential to the means for solution according to the present disclosure.

According to a first exemplary embodiment of the present disclosure, a hyperlink setting program 109 described below acquires product identification information from a first product-specific page. Then, the hyperlink setting program 109 determines whether to directly access a second product-specific page or to access the second product-specific page via a product selection page based on whether the product identification information can be acquired or not.

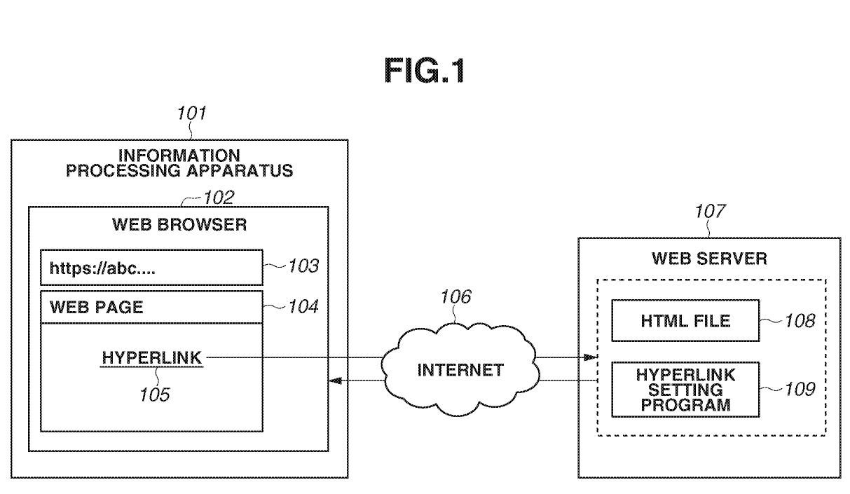

FIG. 1 illustrates a configuration example of a web page display system according to the present disclosure. An information processing apparatus 101 can communicate with an Internet 106. Examples of the information processing apparatus 101 include a personal computer (PC), a smartphone, and a tablet. The information processing apparatus 101 includes a web browser 102.

The web browser 102 is an application program that includes a Uniform Resource Locator (URL) input field 103 and a web content display area 104. The web browser 102 acquires a HyperText Markup Language (HTML) file 108 corresponding to a URL displayed on the URL input field 103, from a web server 107 via the Internet 106. Then, the web browser 102 displays an HTML content included in the HTML file 108 on the web content display area 104.

The HTML content displayed on the web content display area 104 includes a hyperlink 105 in which a URL of another web page is set.

In response to a user pressing the hyperlink 105, the web browser 102 acquires an HTML content corresponding to the URL set in the hyperlink 105 from the web server 107 via the Internet 106. Then, the HTML content is displayed on the web content display area 104.

The hyperlink setting program 109 is a program for acquiring the product identification information included in the first product-specific page and updating the URL of the hyperlink to the second product-specific page included in a product common page based on the acquired information.

The hyperlink setting program 109 is configured with a script file of JavaScript® and the like, and is transmitted to the web browser 102 via the Internet 106 together with the HTML file 108. The hyperlink setting program 109 is executed by the web browser 102 at the time of displaying the HTML file 108.

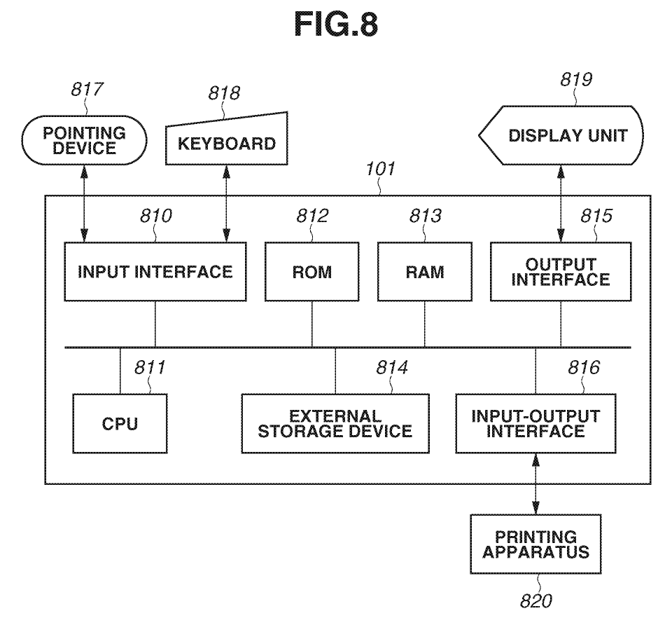

FIG. 8 is a block diagram illustrating a hardware configuration of the information processing apparatus 101. In FIG. 8, the information processing apparatus 101 includes an input interface 810, a central processing unit (CPU) 811, a read-only memory (ROM) 812, a random access memory (RAM) 813, an external storage device 814, an output interface 815, and an input-output interface 816. Input devices, such as a keyboard 818 and a pointing device 817, are connected to the input interface 810 and the output interface 815 is connected to a display device, such as a display unit 819.

The ROM 812 stores therein an initialization program, and the external storage device 814 stores therein an application program group, an operating system (OS), a web browser application, and the like. The RAM 813 is used as a work memory and the like in execution of various programs stored in the external storage device 814.

According to the present exemplary embodiment, the CPU 811 executes processing according to a procedure of a program stored in the external storage device 814, and thus a function describe below and processing according to a flowchart described below of the information processing apparatus 101 are executed. The CPU 811 executes display control processing using the web browser application and operates to display a web page described below.

A printing apparatus 820 may be connected to the information processing apparatus 101 via the input-output interface 816. While, an inkjet printer that performs printing by ejecting ink on a sheet surface is described as an example of the printing apparatus, printing may be executed using another method (for example, an electrophotographic method). The information processing apparatus 101 may be a desktop computer, a smartphone, or a laptop computer.

Usage examples of the Internet include a case where the user uses the Internet to browse information about a particular product. The user accesses a web page related to the product on the website and browses information of the product that the user wants to browse.

The user can use a web page for selecting the product (hereinbelow, referred to as a product selection page) when browsing the web page related to the product information. The user presses a hyperlink, which describes information, such as a product name or a product model number for identifying the product (hereinbelow, referred to as product identification information) listed in the product selection page. By this operation, a web page related to the selected product identification information is displayed on the web browser 102. The user can access a web page that includes a content different among products (hereinbelow, referred to as a product-specific page) from a web page that is commonly used among a plurality of products (hereinbelow, referred to as a product common page) by using the product selection page. In other words, the product common page is a web page that includes a product-independent content.

In using the product selection page, there can be a case where a product-specific page that is accessed after determination of display target product includes a plurality of pages, instead of a single page. The plurality of pages includes a page including a description that is different for each product and a page including the same description among the plurality of products. In order to streamline production, it is common practice to share the page including the same description among the plurality of products.

In such a case, in a case where the user shifts display of a web page from a certain product-specific page (a first product-specific page) to the product common page, and then further accesses a subsequent product-specific page (a second product-specific page), there is a possibility that the product identification information is lost in the product common page. In this case, the user needs to select the display target product again before accessing the second product-specific page.

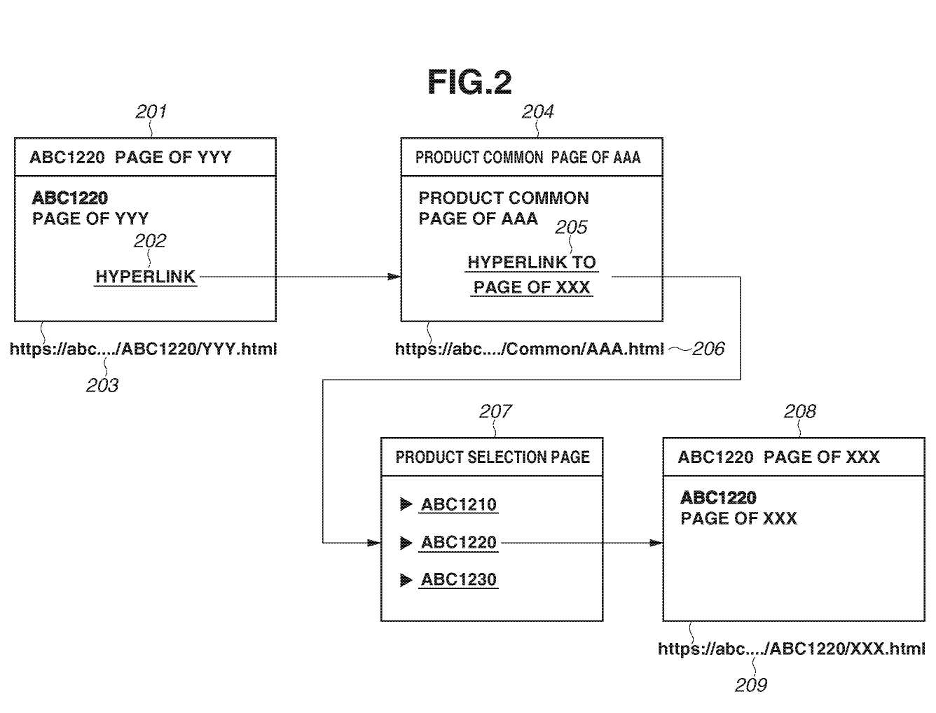

FIG. 2 illustrates an example of a web page flow in which a web page is shifted from the first product-specific page to the product common page and is further shifted to the second product-specific page via the product selection page. A first product-specific page 201 is a product-specific page corresponding to product identification information "ABC1220" and includes a hyperlink 202 for accessing a product common page 204. A URL 203 corresponds to the first product-specific page 201 and includes a product identification name "ABC1220" therein. The first product-specific page is also referred to as a reference source web page.

The product common page 204 is referred via the hyperlink 202 and is a web page that is accessed via the product-specific pages each supporting a different piece of the product identification information.

The product common page 204 includes a hyperlink 205 for use in accessing a product selection page 207. A URL 206 is a URL of the product common page 204. The product common page 204 is a page commonly used by a plurality of products, and thus does not include the product identification information, such as the product name "ABC1220" in the URL 206.

The product selection page 207 is referred via the hyperlink 205 and includes hyperlinks for use in accessing a second product-specific page 208 for the number of targets of pieces of the product identification information. The second product-specific page 208 is referred via the product common page 204 by a route passing through the product selection page 207. A URL 209 corresponds to the second product-specific page 208 and includes therein the product identification name "ABC1220", similar to the URL 203.

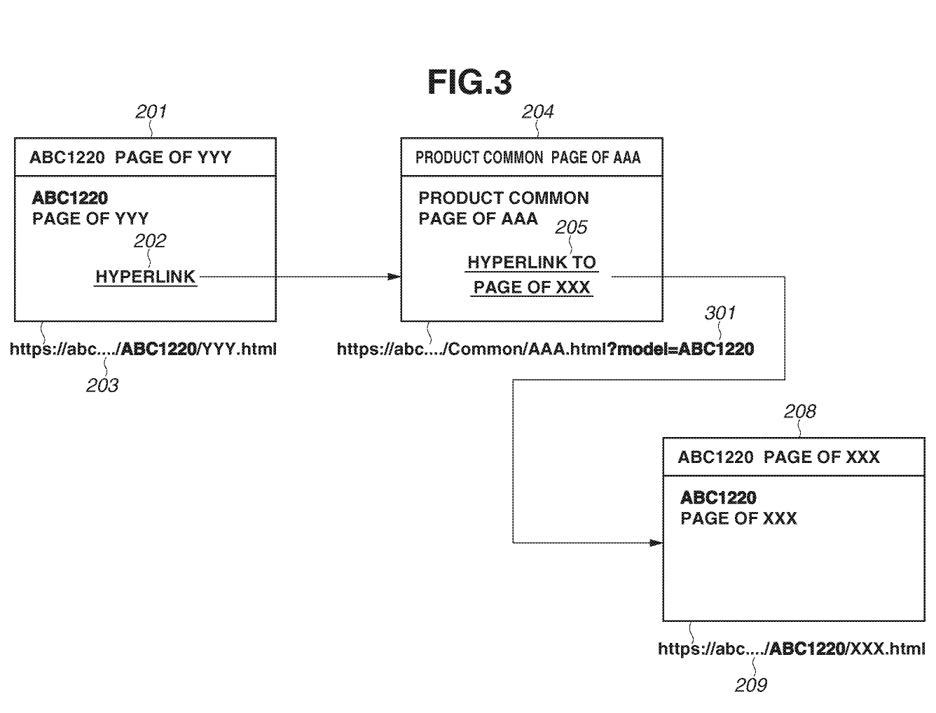

FIG. 3 illustrates an example of a web page flow in a case where the product identification information of the first product-specific page can be acquired. In response to the user pressing the hyperlink 202 described in the first product-specific page 201, the web browser 102 executes the hyperlink setting program 109, and the product common page 204 is displayed after completion of the processing of the hyperlink setting program 109. The first product-specific page 201 corresponds to the printing apparatus connected to the information processing apparatus 101. For example, the information processing apparatus 101 receives identification information of the printing apparatus from the printing apparatus connected to the input-output interface 816. Then, the web browser 102 accesses the web server 107 to display product information. In this process, in a case where the web browser 102 performs the access using the identification information of the printing apparatus acquired via the input-output interface 816, the first product-specific page 201 corresponding to the printing apparatus connected to the information processing apparatus 101 is displayed.

In a case where the web browser 102 executes the hyperlink setting program 109, the product identification information stored in the first product-specific page 201 is acquired from a URL or a URL query parameter. The URL query parameter is additional information of the URL to be transmitted to the web server 107 and is described at the end of the URL. In FIG. 3, a web page creator sets the URL query parameter in which the product identification information is added to the hyperlink 202 as the URL of the product common page 204. Then, the hyperlink setting program 109 acquires the URL query parameter as the product identification information of the first product-specific page 201. A URL 301 is a URL of the product common page 204 in FIG. 3, and the product identification information "ABC1220" acquired by the hyperlink setting program 109 is set in a query parameter "model".

The hyperlink setting program 109 sets the URL 209 in which the acquired product identification information ("ABC1220" in the example in FIG. 3) is incorporated, in the URL of the hyperlink 205.

The web browser 102 displays the product common page 204 in the web content display area 104. In response to the user pressing the hyperlink 205, unlike FIG. 2, the web browser 102 accesses the second product-specific page 208 without accessing the product selection page 207.

In FIG. 3, while the hyperlink setting program 109 acquires the product identification information from the URL query parameter in the URL of the hyperlink 202, the product identification information may be acquired from the URL 203 of the first product-specific page 201.

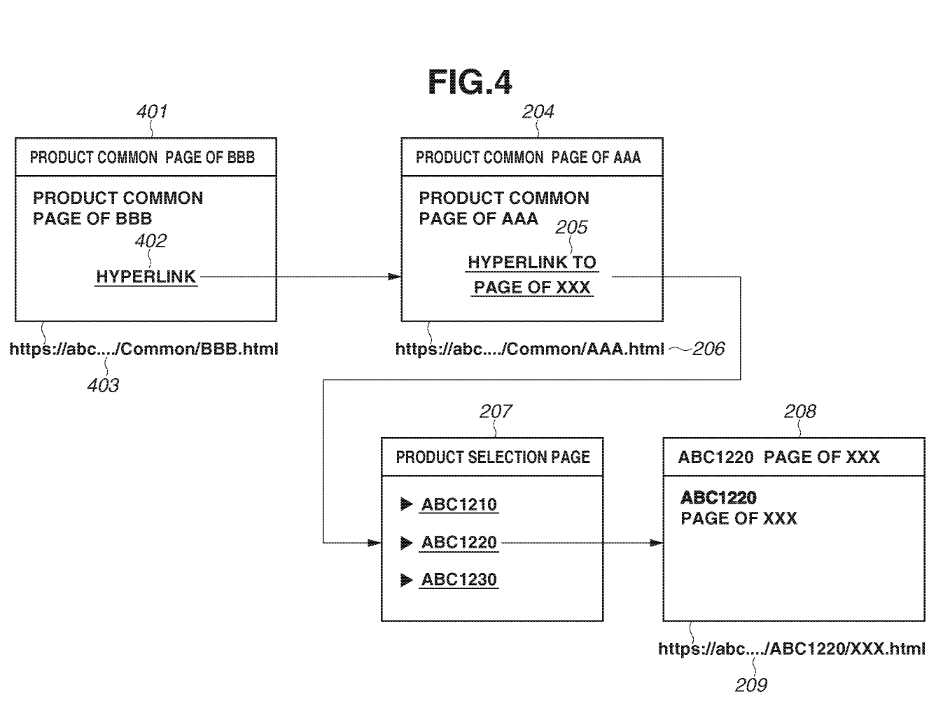

FIG. 4 illustrates an example of a web page flow in a case where the product identification information of the first product-specific page cannot be acquired. In FIG. 4, as an example case where the product identification information of the first product-specific page cannot be acquired, a product common page that does not include the product identification information in the URL or the URL query parameter is displayed instead of the first product-specific page 201. A first product common page 401 includes a hyperlink 402 for accessing the product common page 204. A URL 403 is a URL of the first product common page 401. The URL 403 does not include therein the product identification information, which is a difference from the URL 203.

FIG. 4 illustrates the web page flow in a case where the first product common page 401 is displayed instead of the first product-specific page 201. This web page flow in FIG. 4 can also be applied to a case in which the hyperlink setting program 109 cannot normally acquire the product identification information of the first product-specific page 201. Examples of such a case include a case in which a part or all of information of an acquired URL or URL query parameter is missing (not illustrated).

Since The URL of the hyperlink 402 in FIG. 4 does not include the product identification information, the hyperlink setting program 109 cannot acquire the product identification information from the first product common page 401. Thus, in FIG. 4, the hyperlink setting program 109 sets a URL of the product selection page 207 in the hyperlink 205. The user accesses the second product-specific page 208 via the product selection page 207.

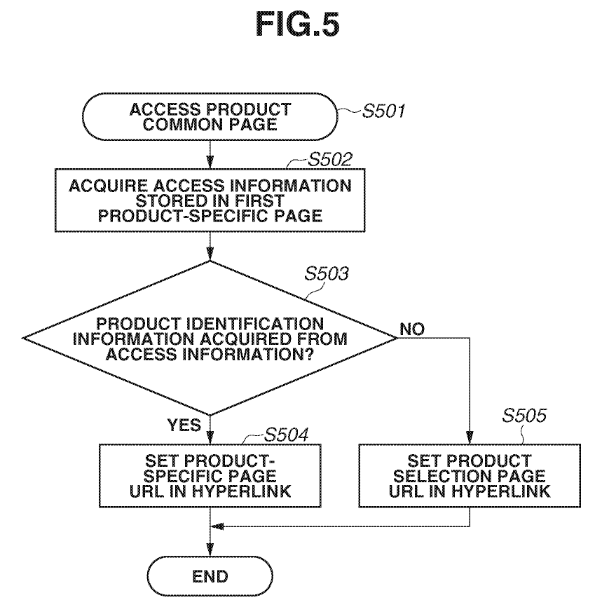

FIG. 5 is a flowchart illustrating a processing procedure according to the first exemplary embodiment. In response to the user pressing the hyperlink 202 included in the first product-specific page 201 or the hyperlink 402 included in the first product common page 401, the web browser 102 executes the hyperlink setting program 109 to start processing in the flowchart in FIG. 5. After completion of the processing in the flowchart in FIG. 5, the web browser 102 displays the HTML content of the product common page 204 in the web content display area 104 of the web browser 102.

The user presses the hyperlink 202 included in the first product-specific page 201 or the hyperlink 402 included in the first product common page 401. In this case, in step S501, the web browser 102 executes access processing using the URL of the product common page 204 set in the hyperlink 202 or 402. In step S501, in a case where the web browser 102 accesses the URL of the product common page 204, the product common page 204 and the hyperlink setting program 109 are transmitted from the web server 107 to the web browser 102.

In step S502, the hyperlink setting program 109 acquires the URL or the URL query parameter as access information from the first product-specific page 201 or the first product common page 401. For example, the URL 203 in FIG. 3 or the URL 301 set in the hyperlink 202 in FIG. 3 is acquired. Alternatively, the URL 403 in FIG. 4 or the URL 206 set in the hyperlink 402 in FIG. 4 is acquired.

In step S503, the hyperlink setting program 109 checks whether the product identification information can be acquired from the acquired access information. A detailed description is given of the processing in step S503. First, the hyperlink setting program 109 determines whether the URL query parameter is included in the acquired access information. In a case where the hyperlink setting program 109 determines that the URL query parameter is included, the hyperlink setting program 109 determines as YES in step S503. For example, in a case where the URL 301 is acquired as the access information, the URL query parameter (i.e., "?model = ABC1220") can be acquired. Thus, the hyperlink setting program 109 determines as YES in step S503. In a case where the hyperlink setting program 109 determines that the URL query parameter is not included in the access information (NO in step S503), the hyperlink setting program 109 performs next processing. More specifically, in a case where the URL 203 as in FIG. 3 is acquired in step S502, the hyperlink setting program 109 divides the URL and acquires a character string at a predetermined position. In the example case according to the present exemplary embodiment, a character string in a second position from the back (i.e., "ABC1220") is acquired. Then, the hyperlink setting program 109 compares the acquired character string with a product identification information list held in the hyperlink setting program 109. In a case where the acquired character string is included in the product identification information list, the hyperlink setting program 109 determines as YES in step S503. Since determination processing using the URL query parameter does not include division processing of the URL and comparison processing using the product identification information list, the processing can be efficiently realized by executing the processing in step S503 by the above-described procedure. In a case where the hyperlink setting program 109 can acquire the product identification information (YES in step S503), the processing proceeds to step S504. In step S504, the URL of the second product-specific page 208 is set in the URL of the hyperlink 205 included in the product common page 204.

On the other hand, in a case where the hyperlink setting program 109 cannot acquire the product identification information (NO in step S503), the processing proceeds to step S505. In step S505, the URL of the product selection page 207 is set in the URL of the hyperlink 205 included in the product common page 204.

A detailed description is given of the processing in steps S504 and S505. The hyperlink setting program 109 holds a URL including variable information and a URL of the product selection page as the URL of the hyperlink 205. In a case where the hyperlink setting program 109 determines as YES in step S503, the hyperlink setting program 109 selects the URL including the variable information and replaces the variable information with the product identification information that can be acquired in step S503. By this processing, for example, the URL 209 in FIG. 3 is generated. Then, the hyperlink setting program 109 sets the URL 209 in the hyperlink 205 of the product common page 204 in FIG. 3.

On the other hand, in a case where the hyperlink setting program 109 determines as NO in step S503, the hyperlink setting program 109 selects the product selection page URL and sets it in the hyperlink 205 in the product common page 204 in FIG. 4.

The web browser 102 displays the product common page 204 generated by setting processing in step S504 or S505.

As described above, according to the first exemplary embodiment, in a case where the hyperlink setting program 109 can acquire the product identification information, the web browser 102 can display the second product-specific page 208 without displaying the product selection page 207. On the other hand, in a case where the hyperlink setting program 109 cannot acquire the product identification information, the web browser 102 can display the product selection page 207 to cause the user to select the product identification information.

Accordingly, the web browser 102 displays the product selection page 207 in a case where selection of the product identification information is required, according to a web page browsing state of the user, whereby operability of a user can be improved compared with a conventional web page flow. Further, since the URL or the URL query parameter is used without using cookies, the processing in the flowchart in FIG. 5 can be stably executed while the user is not affected by usage restrictions on cookies.

While, in the first exemplary embodiment, the hyperlink setting program 109 transmitted from the web server 107 is executed in the web browser 102, the hyperlink setting program 109 can be configured to be executed in the web server 107. In this case, the hyperlink setting program 109 executes acquisition processing of the product identification information and setting processing of the URL of the hyperlink 205 with respect to the HTML file 108 in the web server 107.

Then, the web browser 102 executes display processing based on the HTML file 108 obtained by the above-described processing.

In a second exemplary embodiment, a description is given of an example case in which processing for acquiring product identification information from a first product-specific page and determining whether the acquired product identification information is that of a product supported by a second product-specific page is added to the processing according to the first exemplary embodiment. A redundant detailed description of the processing that overlaps with the description of the first exemplary embodiment is omitted.

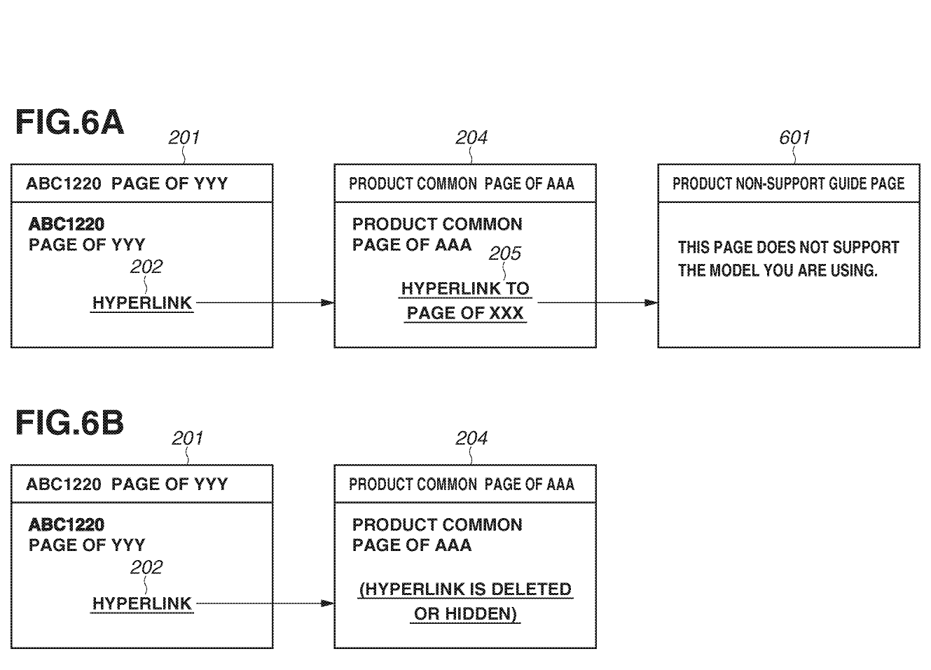

FIG. 6A illustrates an example in which, in a case where the product identification information acquired from the first product-specific page is not included in the products supported by the second product-specific page, accessing to a product non-support guide page instead of the second product-specific page is performed.

In response to the user pressing the hyperlink 202 described in the first product-specific page 201, the web browser 102 displays the product common page 204, similar to the first exemplary embodiment. In a case where the hyperlink setting program 109 can acquire the product identification information of the first product-specific page 201, the hyperlink setting program 109 determines whether the product identification information is included in the products supported by the second product-specific page 208. In a case where the product identification information is included in the products supported by the second product-specific page 208, the hyperlink setting program 109 sets the URL of the second product-specific page 208 in the URL of the hyperlink 205 in the product common page 204 (not illustrated). In a case where the product identification information is not included in the products supported by the second product-specific page 208, the hyperlink setting program 109 sets a URL of a product non-support guide page 601 in the URL of the hyperlink 205, and the web browser 102 displays the product common page 204.

The product non-support guide page 601 is a web page that displays a message notifying that the product identification information acquired by the hyperlink setting program 109 does not correspond to the products supported by the second product-specific page 208. The product non-support guide page 601 may be configured as a product common web page for displaying a fixed message or may be configured to change a content in the page based on the product identification information acquired from the first product-specific page 201.

FIG. 6B illustrates an example in which, in a case where the product identification information acquired from the first product-specific page 201 is not included in the products supported by the second product-specific page 208, the hyperlink 205 for accessing from the product common page 204 to the second product-specific page 208 is deleted or hidden. In the product common page 204 in FIG. 6B includes "(HYPERLINK IS DELETED OR HIDDEN)", but actually, the web browser 102 does not display both of the hyperlink 205 and this description to prevent the user from pressing the hyperlink 205.

Similar to FIG. 3, in a case where the product identification information can be acquired from the first product-specific page 201, the hyperlink setting program 109 determines whether the product identification information is included in the products supported by the second product-specific page 208. In a case where the acquired product identification information is included in the products supported by the second product-specific page 208, the hyperlink setting program 109 sets the URL of the second product-specific page 208 in the URL of the hyperlink 205 in the product common page 204 (not illustrated). In a case where the acquired product identification information is not included in the products supported by the second product-specific page 208, the hyperlink setting program 109 deletes or hides the hyperlink 205 from the product common page 204.

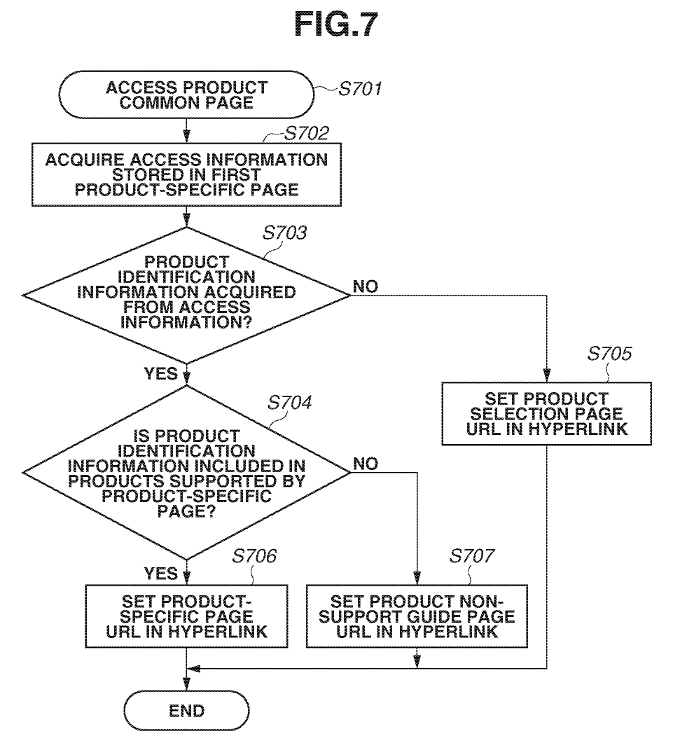

FIG. 7 is a flowchart illustrating a procedure of the processing in FIG. 6A. A procedure of the processing in FIG. 6B is similar to the flowchart in FIG. 7 except the processing in step S707 (described below). Similar to FIG. 5, a description for FIG. 7 is started from processing in which a user accesses the product common page 204 by pressing the hyperlink 202 included in the first product-specific page 201 or the hyperlink 402 included in the first product common page 401.

Processing in steps S701, S702, S703, and S705 in FIG. 7 are similar to the processing in steps S501, S502, S503, and S505 in FIG. 5. Thus, redundant descriptions of the processing in each step S701, S702, S703, and S705 is omitted.

In step S703, in a case where the hyperlink setting program 109 can acquire the product identification information (YES in step S703), the processing proceeds to step S 704. In step S704, the hyperlink setting program 109 determines whether the acquired product identification information is included in the products supported by the second product-specific page 208. A detailed description is given of the processing in step S704. The hyperlink setting program 109 acquires information on products supported by the second product-specific page 208 from the web server 107. Then, the hyperlink setting program 109 determines whether the product identification information acquired in step S703 is included in the information on products supported by the second product-specific page 208.

In a case where the acquired product identification information is included in the products supported by the second product-specific page 208 (YES in step S704), the processing proceeds to step S706. In step S706, the hyperlink setting program 109 sets the URL 209 of the second product-specific page 208 in the URL of the hyperlink 205 included in the product common page 204. Because processing in step S706 is similar to that in step S506, the redundant detailed description is omitted.

In a case where the acquired product identification information is not included in the products supported by the second product-specific page 208 (NO in step S704), the processing proceeds to step S707. In step S707, the hyperlink setting program 109 sets a URL of the product non-support guide page 601 in the URL of the hyperlink 205 included in the product common page 204.

The hyperlink setting program 109 holds the URL of the product non-support guide page 601 as the URL of the hyperlink 205 in addition to that according to the first exemplary embodiment. In a case where the hyperlink setting program 109 determines as NO in step S704, the hyperlink setting program 109 selects the URL of the product non-support guide page 601 and sets the URL in the hyperlink 205 in the product common page 204.

The flowchart in FIG. 7 can be applied to the processing procedure in FIG. 6B. In the processing in the flowchart in FIG. 7, the processing in step S707 is different between FIG. 6A and FIG. 6B. In a web page flow in FIG. 6A, the URL of the product non-support guide page 601 is set in the URL of the hyperlink 205 in the processing in step S707, whereas in a web page flow in FIG. 6B, the hyperlink 205 is deleted or hidden by the processing in step S707 (not illustrated).

As described above, according to the second exemplary embodiment, the product non-support guide page is displayed, whereby user operability can be improved. The web page is displayed in such a way that a user cannot operate the hyperlink as illustrated in FIG. 6B, and thus user convenience can also be improved.

According to the second exemplary embodiment, similar to the first exemplary embodiment, the hyperlink setting program 109 can also be configured to be executed in the web server 107.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A method performed by one or more processors of an information processing apparatus that provides a product common page which is commonly used among a plurality of products, the method comprising:
determining, by the one or more processors, whether product identification information is included in a Uniform Resource Locator (URL) query parameter of a reference source web page;
acquiring, by the one or more processors and based on the determination, the product identification information from one of the URL query parameter or a URL of the reference source web page; and
generating, by the one or more processors,
(a) in response to determining that the product identification information is acquired from the URL query parameter of the reference source web page, a product common page including a first type of hyperlink in which a URL dynamically generated from a parameter value at a predetermined position within the URL query parameter is set; and
(b) in response to determining that the product identification information is not acquired from the URL query parameter, a product common page including a second type of hyperlink in which a predetermined product selection URL not based on the product identification information is set,
wherein, when the first type of hyperlink is selected, a web page related to a product corresponding to the product identification information is provided.

2. The method according to claim 1, wherein the predetermined product selection URL provided in the second type of hyperlink, in response to determining that the product identification information is not acquired from the URL query parameter, is a URL of a product selection page.

3. The method according to claim 1, wherein the product identification information is acquired from a URL query parameter of the reference source web page.

4. The method according to claim 3, wherein the product identification information is acquired from a parameter value at a predetermined position within the URL query parameter of the reference source web page.

5. The method according to claim 1, wherein the determining comprises determining whether the product identification information is included in a URL query parameter of the reference source web page, and in response to determining that the product identification information is not included in the URL query parameter, acquiring the product identification information from a URL of the reference source web page.

6. The method according to claim 1, wherein, in response to acquiring identification information of a printing apparatus, the reference source web page is displayed based on the identification information.

7. An information processing apparatus that provides a product common page which is commonly used among a plurality of products, the information processing apparatus comprising:
one or more memories storing instructions; and
one or more processors coupled to the one or more memories and configured to execute the instructions to:
determine whether product identification information is included in a Uniform Resource Locator (URL) query parameter of a reference source web page;
acquire, based on the determination, the product identification information from one of the URL query parameter or a URL of the reference source web page; and
generate:
(a) in response to determining that the product identification information is acquired from the URL query parameter of the reference source web page, a product common page including a first type of hyperlink in which a URL dynamically generated from a parameter value at a predetermined position within the URL query parameter is set; and
(b) in response to determining that the product identification information is not acquired from the URL query parameter, a product common page including a second type of hyperlink in which a predetermined product selection URL not based on the product identification information is set,
wherein, when the first type of hyperlink is selected, a web page related to a product corresponding to the product identification information is provided.

8. The information processing apparatus according to claim 7, wherein the predetermined product selection URL provided in the second type of hyperlink, in response to determining that the product identification information is not acquired from the URL query parameter, is a URL of a product selection page.

9. The information processing apparatus according to claim 7, wherein the product identification information is acquired from a URL query parameter of the reference source web page.

10. The information processing apparatus according to claim 9, wherein the product identification information is acquired from a parameter value at a predetermined position within the URL query parameter of the reference source web page.

11. The information processing apparatus according to claim 7, wherein the processor is configured to determine whether the product identification information is included in a URL query parameter of the reference source web page, and in response to determining that the product identification information is not included in the URL query parameter, to acquire the product identification information from a URL of the reference source web page.

12. A non-transitory computer-readable storage medium storing a program that, when executed by one or more processors of an information processing apparatus, causes the one or more processors to perform a method that displays a product common page which is commonly used among a plurality of products, the method comprising:
determining, by the one or more processors, whether product identification information is included in a Uniform Resource Locator (URL) query parameter of a reference source web page;
acquiring, by the one or more processors and based on the determination, the product identification information from one of the URL query parameter or a URL of the reference source web page; and
generating, by the one or more processors,
(a) in response to determining that the product identification information is acquired from the URL query parameter of the reference source web page, a product common page including a first type of hyperlink in which a URL dynamically generated from a parameter value at a predetermined position within the URL query parameter is set; and
(b) in response to determining that the product identification information is not acquired from the URL query parameter, a product common page including a second type of hyperlink in which a predetermined product selection URL not based on the product identification information is set,
wherein, when the first type of hyperlink is selected, a web page related to a product corresponding to the product identification information is provided.

13. The method according to claim 1, wherein, in response to determining that the product identification information is not acquired from the URL query parameter, the predetermined product selection URL provided in the second type of hyperlink is a URL of a product selection page.

14. The method according to claim 1, wherein, in response to determining that the product identification information is not acquired from the URL query parameter, the product common page does not include the first type of hyperlink in which the URL dynamically generated based on the product identification information is set.
